(19) United States
(12) Patent Application Publication
(10) Pub. No.: US 2008/0273729 A1
(43) Pub. Date: Nov. 6, 2008

(54) Assembly Method For Custom Hearing Aids

(75) Inventors: Oleg Saltykov, Fair Lawn, NJ (US); Fred McBagonluri, East Wndsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS HEARING INSTRUMENTS INC., Piscataway, NJ (US)

(21) Appl. No.: 11/742,633

(22) Filed: May 1, 2007

(51) Int. Cl. H04R 25/00

(52) U.S. Cl. 381/324

(57) ABSTRACT

A hearing aid and appertaining method of assembly are provided in which a receiver assembly is placed within a shell of the hearing aid, the receiver assembly comprising a left and right stud. A receiver tube is connected to the receiver assembly and extends through a hole in a supporting plate and shell tip respectively. A permanent latch is provided comprising a cavity into which the first stud of the receiver assembly is located when the receiver assembly is in its designated position. An external rail latch slides on the external rail and secures the receiver assembly in its designated position by interfacing with the second stud.

### BACKGROUND

The present invention is directed to an assembly method for custom hearing aids. Hearing aids are comprised of a shell into which various components, such as amplifying circuitry, transducers, etc. are placed.

Existing constructions of custom hearing aids do not provide a definite position of the components inside the shell. When assembling the hearing aid components, an assembly worker positions the faceplate components into the shell without seeing the results. The lack of control may cause a damage of the faceplate components, or may create a feedback situation when the hearing aid is in use due to an unexpected interaction of the faceplate components with the receiver.

One proposed construction and assembly method of a custom hearing aid is disclosed in U.S. Patent Publication No. 2005/0074138 (“the '138 Publication”), filed Sep. 21, 2004, herein along with its parent incorporated by reference. The 1138 Publication addresses the issues of assembling hearing instruments with conventional faceplates. In such instruments, the shell is widely open during the assembly, which allows for an easy access to the receiver component. The receiver position can be adjusted and the suspended peripheral components can be readily plugged into the matching cavities of the latches. However, this application does not address problems of assembling In-the-Ear (ITE) instruments with Semi-Modular (SM) inserts.

### SUMMARY

The goals of the present invention are to speed up the closing of custom hearing aids, to improve the consistency of performance, and to avoid damaging the components. The present method disclosed allows for a quick closing of a hearing instrument with the consistent results, and allows for a reliable assembly of an ITE instruments with an SM insert (where access to the receiver assembly is very limited) with all the benefits that the design according to the disclosure of the '138 Publication offers for conventional (non-SM) instruments.

Accordingly, a method is provided for assembling a hearing aid shell, comprising attaching a receiver tube to a receiver assembly; pulling the receiver tube through holes in a supporting plate and shell tip to its final pre-designated position; moving, during the pulling, a first stud of the receiver assembly into a cavity of a permanent latch of the shell, until the first stud is at its final pre-designated position; and inserting an external rail latch onto a rail, such that the latch secures a second stud of the receiver assembly, thereby securing the receiver assembly at the pre-designated position.

Additionally, a hearing aid is provided, comprising a shell; a receiver assembly that primarily resides within the shell, the receiver assembly comprising a first and second stud; a receiver tube connected to the receiver assembly and extending through a hole in a supporting plate and shell tip respectively; a permanent latch comprising a cavity into which the first stud of the receiver assembly is located when the receiver assembly is in its designated position; an external rail; and an external rail latch that slides on the external rail and secures the receiver assembly in its designated position by interfacing with the second stud.

### DESCRIPTION OF THE DRAWINGS

The invention is described with reference to various preferred embodiments illustrated in the drawings and described in more detail below.

FIG. 1A is a pictorial isometric illustration of a receiver positioned within an ITE shell with an SM insert;

FIG. 1B is a top view pictorial illustration of the ITE shell shown in FIG. 1A;

FIG. 1C is a pictorial isometric illustration of an SM insert;

FIG. 2 is a pictorial illustration of the ITE shell of FIG. 1 with an external rail latch attached;

FIG. 3 is an isometric pictorial illustration of the receiver positioned with the external rail latch attached;

FIGS. 4 & 5 correspond to FIGS. 1 and 2 from a different perspective and show the assembly steps;

FIG. 6 is a pictorial isometric illustration of a supporting plate; and

FIG. 7 is a pictorial isometric illustration of a receiver assembly with receiver tube attached.

### DETAILED DESCRIPTION OF THE PREFERRED EMBODIMENTS

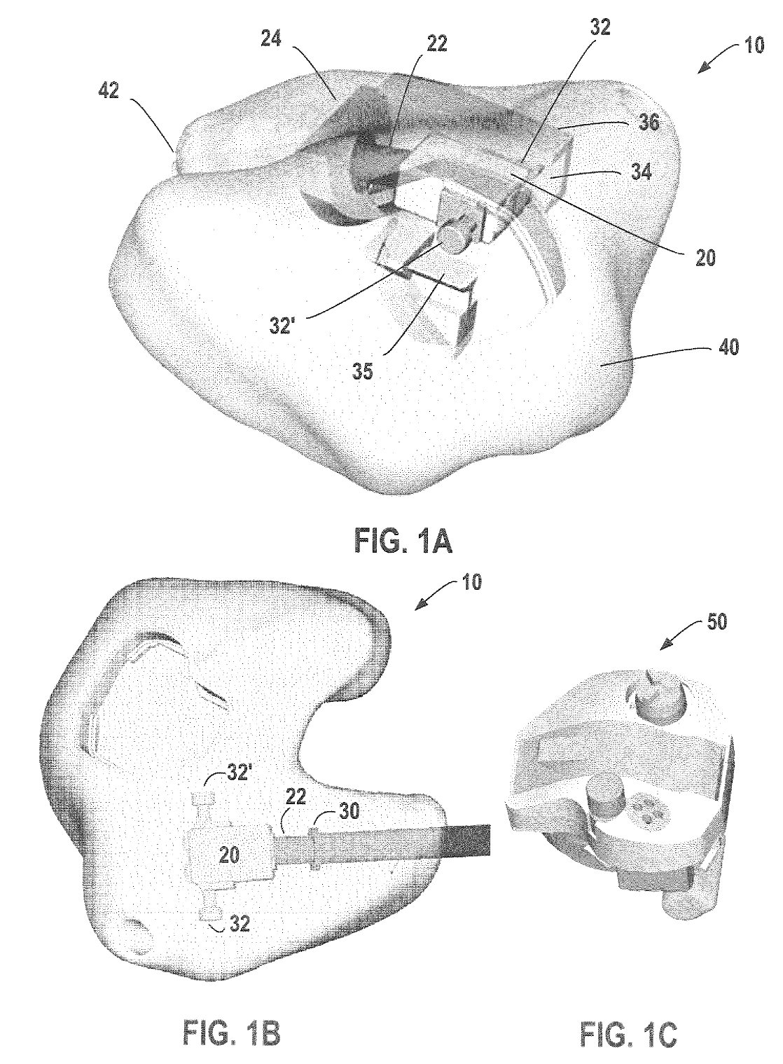

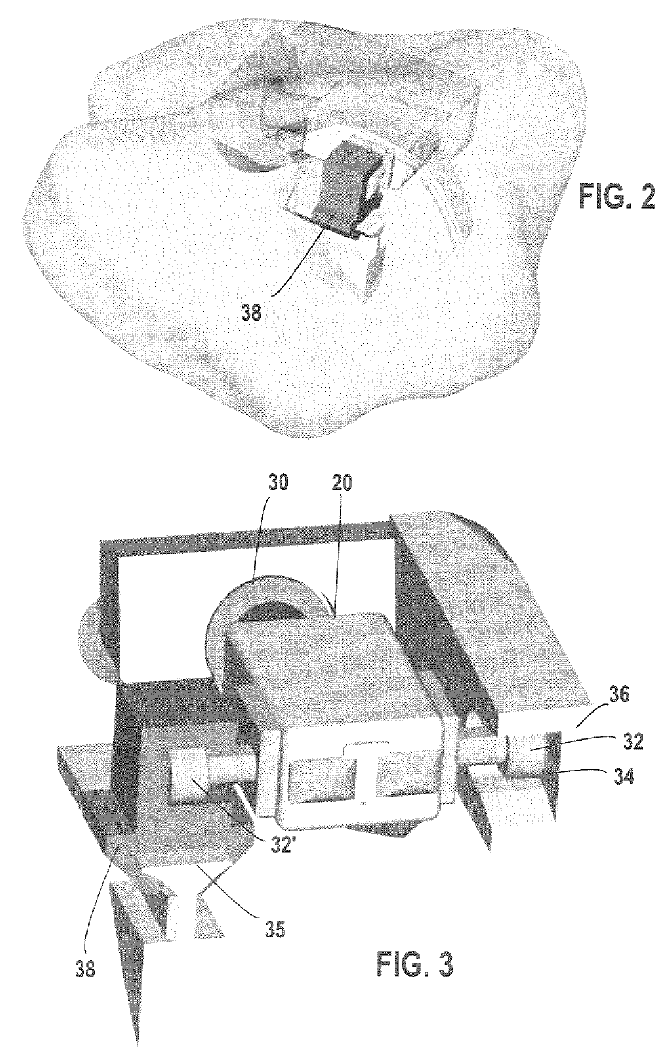

FIGS. 1A-1C and 2 illustrate an embodiment of the invention. An ITE hearing instrument 10 comprises a shell 40 into which a receiver assembly 20 is placed. A receiver tube 22 is connected to the receiver 20 and extends to a shell tip 42. A supporting plate 24 for the tube 22 is also provided. The receiver 20 has a right stud 32 that slides into a cavity 34 of a permanent latch 36. The receiver slides along a ledge 28 for support as it is being placed. FIG. 1C illustrates an exemplary semi-modular (SM) insert 50.

Referring to FIG. 2, the receiver 20 also has a left stud 32′ that is anchored with an external rail latch 38 that slides along a rail 35.

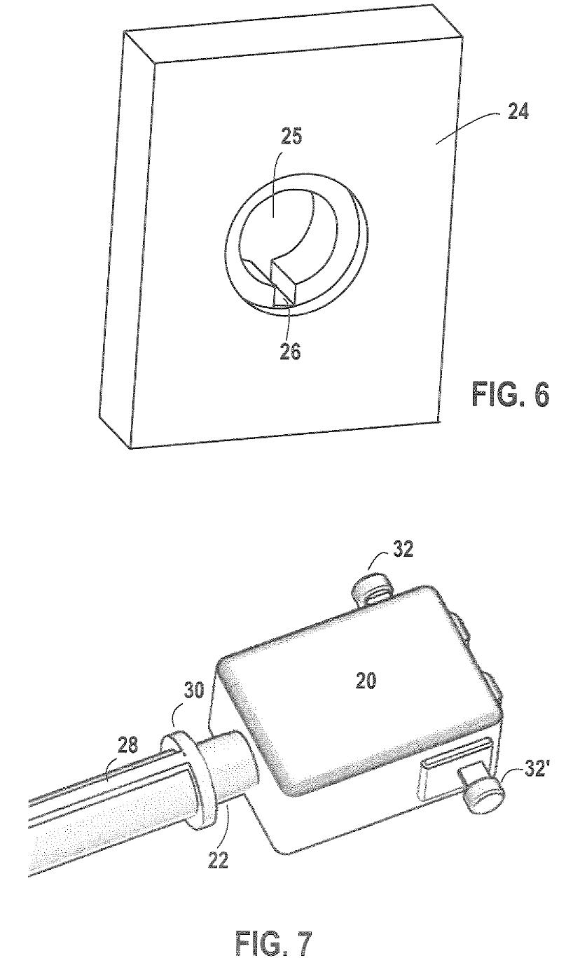

The challenge during the assembly of ITE instruments 10 with an SM insert is due to the fact that there is no access to the receiver assembly 20 for an adjustment—it is almost completely obstructed by the shell 40. FIG. 3 illustrates the assembled device 10 without the shell 40, and more clearly illustrates the internal suspension elements. The receiver 20 with tube (having a ledge 28 and stopper ring 30 and studs 32, 32′ (as disclosed in FIGS. 2 and 3 of the '138 Publication with an opening in the support plate with a keyway as shown in FIG. 14), support wall and a permanent latch 36. This configuration is illustrated in FIGS. 6 and 7.

When the receiver 20 reaches its designated position, the right stud 32 will go into the matching cavity 34 of the permanent latch 36. As can be seen in FIG. 3, in a preferred embodiment, the cavity 34 may be much bigger on an insertion end, with walls narrowing down to guide the right stud 32 of the receiver 20. When the receiver 20 is in place, the cavity 34 matches the shape of the stud 32 so that a relatively snug fit is ensured and proper positioning ensured.

As can be seen in FIGS. 3-5, a rail 35 is provided inside the shell 40 and is merged with the shell body 40. As shown in FIGS. 3 and 5, the external rail latch 38 is inserted onto the rail 35 by the assembler to provide support for the receiver assembly 20. Thus, advantageously, the receiver 20 is supported via an external part 38 that is inserted into a rail 35 produced inside the shell 40.

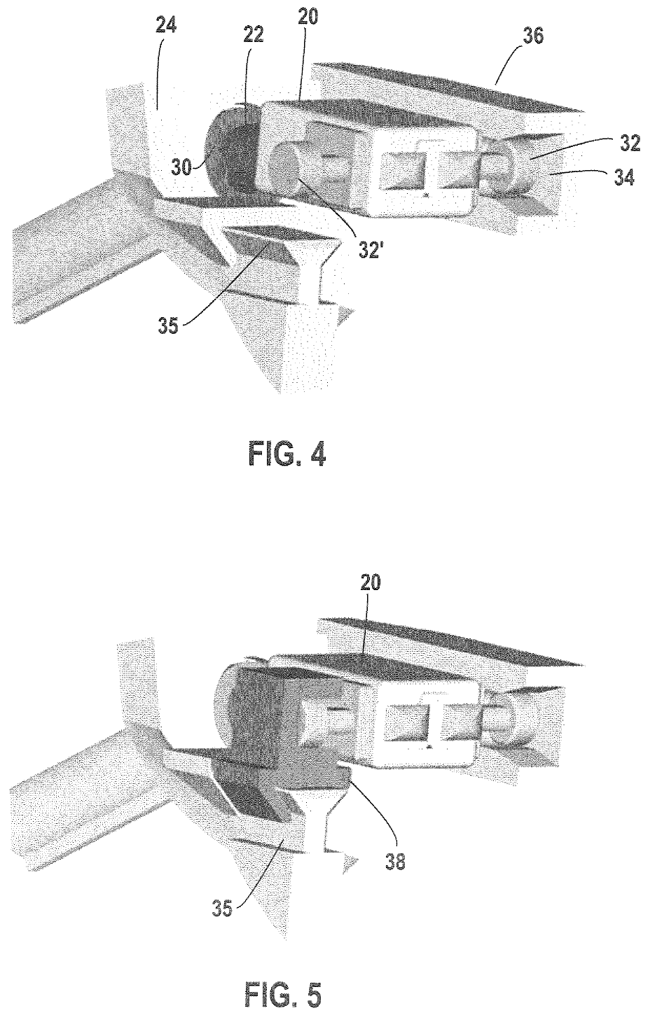

As to the method for manufacturing, the actual assembly may be done in the following order, as illustrated in FIGS. 1A, 6, and 7: the receiver tube 22 is pulled through holes in the supporting plate 24, 25 and the shell tip 42. The receiver assembly 20 is guided towards its designated position by the tube 22 with a ledge 28 that is guided by a slot 26 in the support plate hole 25 and the stopper ring 30 that may, e.g., fit into a recessed portion of the hole 25. When the receiver 20 reaches its designated position, the right stud 32 goes into the matching cavity 34 of the permanent latch 36 (FIG. 4). The external rail latch 38 is then inserted into the rail 35 by an assembler to provide the support for the receiver assembly 20 (FIG. 5).

The proposed construction and the assembly procedure ensures that there are no issues with component damage, mechanical feedback, spikes, etc. in custom instruments with an SM insert, where the access to the receiver assembly is limited.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of components configured to perform the specified functions. The particular implementations shown and described herein are illustrative examples of the invention and are not intended to otherwise limit the scope of the invention in any way. For the sake of brevity, conventional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

### TABLE OF REFERENCE CHARACTERS

| | |
|---|---|
| 10 | In-the-Ear (ITE) hearing aid |
| 20 | receiver assembly |
| 22 | receiver tube |
| 24 | supporting plate |
| 25 | supporting plate hole |
| 26 | supporting plate slot |
| 28 | ledge |
| 30 | stopper ring |
| 32 | right stud |
| 32′ | left stud |
| 34 | cavity |
| 35 | rail |
| 36 | permanent latch |
| 38 | external rail latch |
| 40 | shell |
| 42 | shell tip |
| 50 | semi-modular (SM) insert |

What is claimed is:

1. A method for assembling a hearing aid shell, comprising:
attaching a receiver tube to a receiver assembly;
pulling the receiver tube through holes in a supporting plate and shell tip to its final pre-designated position;
moving, during the pulling, a first stud of the receiver assembly into a cavity of a permanent latch of the shell, until the first stud is at its final pre-designated position; and
inserting an external rail latch onto a rail, such that the latch secures a second stud of the receiver assembly, thereby securing the receiver assembly at the pre-designated position.

2. The method according to claim 1, further comprising:
guiding the receiver assembly as it is being pulled towards its pre-designated position with a ledge;

3. The method according to claim 1, further comprising:
contacting a stopper ring on the tube with a portion of the supporting plate.

4. The method according to claim 1, wherein the portion of the supporting plate is a recessed circular portion.

5. A hearing aid, comprising:
a shell;
a receiver assembly that primarily resides within the shell, the receiver assembly comprising a first and second stud;
a receiver tube connected to the receiver assembly and extending through a hole in a supporting plate and shell tip respectively;
a permanent latch comprising a cavity into which the first stud of the receiver assembly is located when the receiver assembly is in its designated position;
an external rail; and
an external rail latch that slides on the external rail and secures the receiver assembly in its designated position by interfacing with the second stud.

6. The hearing aid according to claim 5, wherein the external rail is merged with the shell.

7. The hearing aid according to claim 5, wherein:
the receiver tube comprises a ledge; and
the supporting plate hole comprises a slot into which the ledge of the receiver tube may be guided as the receiver assembly is moved into its pre-designated position.

8. The hearing aid according to claim 5, wherein the receiver tube extends through a hole in the supporting plate and shell tip respectively.

9. The hearing aid according to claim 5, further comprising a stop ring that extends radially around the receiver tube and forms an interference fit with the supporting plate to prevent over-travel of the receiver tube during placement.

10. A means for mounting a receiver assembly into a shell of a hearing aid, comprising:
a means for guiding the receiver assembly into a pre-designated mounting position;
a plurality of studs that engage mounting means associated with the shell; and
a locking means associated with at least one of the plurality of studs that is slidably mounted on a fixed rail.
